(19) United States
(12) Patent Application Publication
(10) Pub. No.: US 2005/0199833 A1
(43) Pub. Date: Sep. 15, 2005

(54) Optical fluid level monitor

(76) Inventors: David Corven, Washington, MI (US); Grigory Yezersky, Farmington Hills, MI (US); Gerald Cilibraise, Livonia, MI (US)

Correspondence Address: DAIMLERCHRYSLER INTELLECTUAL CAPITAL CORPORATION;CIMS 483-02-19, 800 CHRYSLER DR EAST, AUBURN HILLS, MI, 48326-2757, US

(21) Appl. No.: 10/800,484

(22) Filed: Mar. 15, 2004

(51) Int. Cl. G01N 15/06; H01S 3/30

(52) U.S. Cl. 250/573; 250/901

(57) ABSTRACT

An optical sensor for detecting a level of a liquid in a reservoir, the optical sensor including: a display; a light pipe optically connected to the display and extending to a level of interest in the reservoir, where the light pipe is formed from a material having a refractive index higher than air's refractive index and less than or equal to the liquid's refractive index; and a light optically connected to the light pipe. The term “light pipe” as used herein is intended to refer to a glass rod, a plastic rod, or an optical fiber, a bundle of optical fibers, or the like.

### FIELD OF THE INVENTION

This invention relates to a device for measuring fluid level in a reservoir. More specifically, the present invention describes an optical fluid measuring device useful for checking the level of oil, power steering fluid, washer fluid, etc. in a motor vehicle.

### BACKGROUND OF THE INVENTION

There are many different types of level sensors for monitoring fluid level in a reservoir or tank in common use. The simplest method for determining fluid level is through the use of a dipstick. When the fluid reservoir is in a vehicle, the dipstick is usually housed so that it extends into the tank all the time. Monitoring the fluid level requires removing the dipstick, wiping it clean, reinserting it, and then removing it a second time to check the level. While simple and inexpensive, the dipstick has a number of drawbacks: The process of checking the fluid is rather involved. It requires the use of a cloth or similar material to wipe the dipstick. And dipping into the reservoir creates the likelihood that foreign material will be introduced into the tank.

The most common type of remote level sensor uses a float to determine the liquid level. In its simplest form, a float is connected mechanically to an indicator. As the float moves in response to changes in fluid level, these changes are reflected in the indicator. While more convenient than a dipstick, a completely mechanical float often involves complicated linkages and an opening through which foreign material can be introduced to the reservoir or tank.

In response to a need for reliable sensors a large variety of electric devices have been developed. Typically electronic devices employ a sensor that generates an electrical signal indicative of fluid level. The signal is transmitted via wires to an output device such as a digital or analog indicator. The sensors themselves can be float based or capacitance based, i.e. partially mechanical or wholly electrical. In addition a high degree of reliability, electronic devices can be designed to function well in high NVH (noise-vibration-harshness) environments, and work in harsh fuels and chemicals. (See, for example, U.S. Pat. No. 6,624,755 B1.)

Unfortunately, electronic sensors have a number of drawbacks. Float based electronic sensors have a mechanical component and thus the inherent manual problems. And certain electronic sensors for conductive liquids that utilize conductivity in making a level determination (see, U.S. Pat. No. 6,624,744 B1) are of little use with fuels. The biggest drawback of electronic sensors is that making them function accurately and reliably for use in a variety of applications increases their cost.

In response to the plethora of electronic devices, a variety of optical devices have been designed with the goal of increasing reliability and safety. For example, U.S. Pat. No. 5,687,687 describes a sensor having a series of LED's where each is surrounded by a receiving lens. This sensor is connected to the vehicle ECU which interprets the transmitted signal and displays a low or high indication on the vehicle dash.

An additional type of optical sensor is described in U.S. Pat. Nos. 6,173,609 and 6,668,645. Both these patents describe using a light source, bundled wave guides, and a sensor. The bundled wave guides are configured so that the amount of light from the light source that reaches the sensor is indicative of the fluid volume.

Increased reliability and safety unfortunately comes with increased complexity and increased cost. While these devices could easily be substituted for a dipstick, they lack the simplicity, reliability, and very low cost that a dipstick provides.

### SUMMARY OF THE INVENTION

One object of the present invention is a fluid measurement device having the simplicity of a dipstick without its inherent drawbacks.

Another object of the present invention is a fluid measurement device that is inexpensive and reliable.

These and other objects of the invention are satisfied by an optical sensor for detecting a level of a liquid in a reservoir, the optical sensor including: a display; a light pipe optically connected to the display and extending to a level of interest in the reservoir, where the light pipe is formed from a material having a refractive index higher than air's refractive index and less than or equal to the liquid's refractive index; and a light optically connected to the light pipe.

### BRIEF DESCRIPTION OF THE DRAWINGS

FIG. 1 is a schematic cross sectional view of an optical level sensor according to the present invention placed in an engine to detect the amount of oil in the pan.

FIG. 2 is a schematic cross sectional view of a bundle of optical level sensors according to the present invention placed in an engine to detect the amount of oil in the pan.

### DETAILED DESCRIPTION

The present invention takes advantage of the behavior of light in a light pipe (i.e., glass rod, plastic rod, or optical fiber) having a specific refraction index when the light pipe is surrounded by air or simultaneously surrounded by air and touching a liquid. Where a light pipe has a refraction index higher than air's refractive index, and if the light pipe is illuminated at one point and surrounded by air, the light stays in the light pipe. In addition, when the light pipe's refractive index is also less the refraction index of a liquid to be measured, when the light pipe is illuminated and touches the liquid, all the light escapes from the light pipe through the liquid.

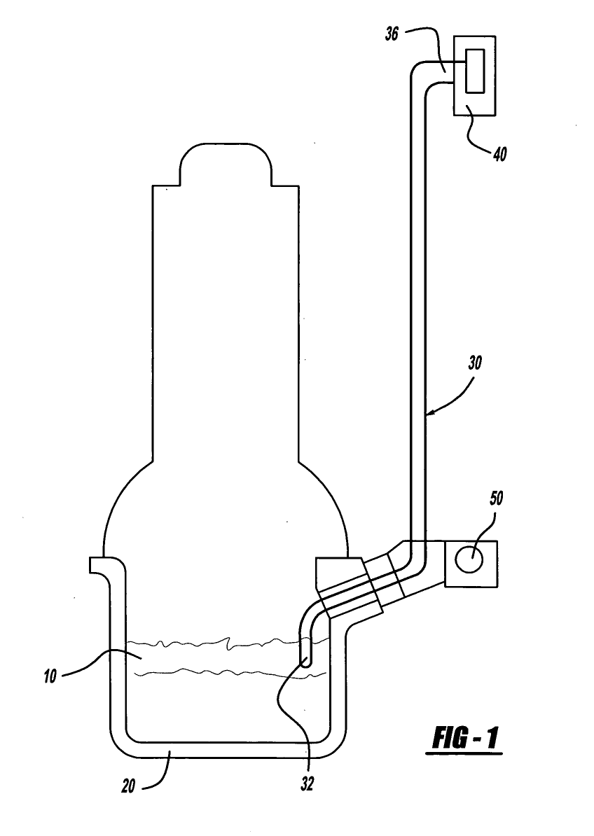

FIG. 1 illustrates an embodiment of the present invention employed to determine oil level 10 in an engine oil pan 20. A light pipe 30 (i.e., glass rod, plastic rod, glass tube, plastic tube, or optical fiber) is positioned in the engine oil pan 20 so that one end 32 is at the level of interest in the oil pan 20 (i.e. the maximum or full level of oil) and the opposite end 36 is connected to a display 40 positioned at any convenient viewing location. A light source 50 (such as a high intensity LED) is connected to illuminate the light pipe 30 at any convenient point.

The light pipe 30 must be formed of a material having an index of refraction greater than air and less than or equal to the index of refraction for the liquid whose level is to be determined. In the example shown in FIG. 1, this means that the light pipe 30 according to the present invention is formed from a material having an index of refraction greater than air and less than or equal to oil. When the light source 50 is illuminated and the oil level is below the level of interest, i.e. the light pipe 30 does not touch the oil and is completely surrounded by air, light from the light source 50 remains in the light pipe and illuminates the display 36. When the oil is at or above the level of interest, i.e. touching the end 32 of the light pipe 30, the light from the light source 50 will escape through the oil and the display 36 will not be illuminated.

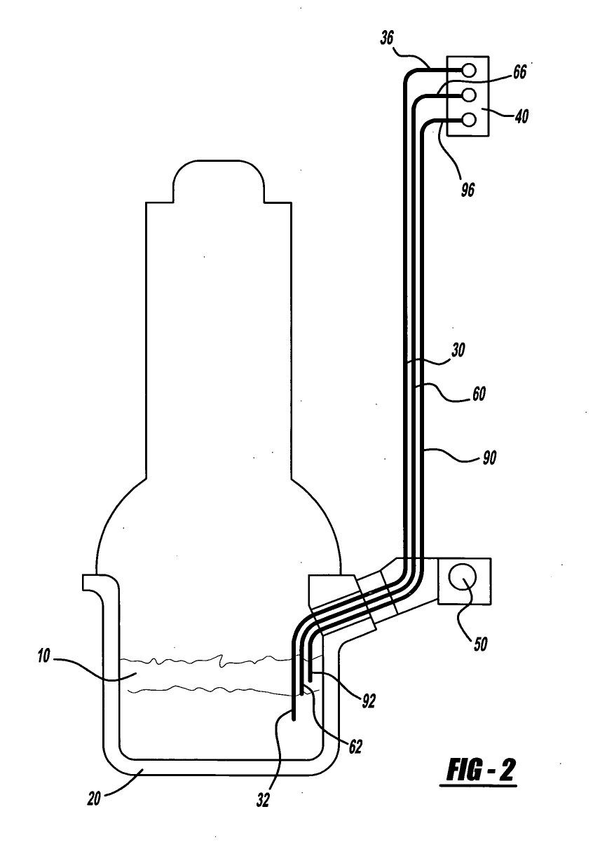

FIG. 2 presents an alternative embodiment of the present invention using a bundle of three light pipes 30, 60, and 90 (i.e., glass rods, plastic rods, glass tubes, plastic tubes, or optical fibers) positioned in the engine oil pan 20 so that the ends 32, 62, and 92 are each at a level of interest in the oil pan 20 (i.e. indicating a low, full, over condition) and the opposite ends 36, 66, and 96 are connected to a display 40 positioned at any convenient viewing location. A light source 50 (such as a high intensity LED) is connected to illuminate the light pipes 30, 60, and 90 at any convenient point. (Alternatively, a single light source may be used for each light pipe.)

In the example illustrated in FIG. 2, the light pipes 30, 60, and 90 are formed of a material having an index of refraction greater than air and less than or equal to the index of refraction of motor oil. With the light source 50 illuminated, and when the oil is below the level of interest 32, 62, and/or 92 for the light pipes 30, 60, and/or 90, i.e. one to all of the light pipes are completely surrounded by air, light from the light source 50 remains in the appropriate light pipe 30, 60, and/or 90 and illuminates the appropriate display 36, 66, and/or 96. When the oil is at or above the level of interest, i.e. touching one to all of the ends 32, 62, and/or 92, the light from the light source 50 will escape through the oil and the corresponding display 36, 66, and/or 96 will not be illuminated. Using three light pipes, for example, makes it possible to display a continuum of fill states in the oil pan.

The number of light pipes used may be varied according to the particular application. The present invention is intended to cover the use of one, two, three, four, to any plurality of light pipes. For example, a bundle of fiber optics may be utilized and arranged at levels of interest in the fluid so as to permit the monitoring of the fluid level in the reservoir from zero to completely full.

In addition, the present invention can be configured in a number of ways. If used as a direct replacement for the dipstick, the display can be placed at a location that is visible only when the hood of the vehicle is open. By configuring the light source 50 to illuminate only when the hood is open, energy is conserved and the useful life of the light source extended. As a dipstick replacement the present invention is ideal. It is easy and inexpensive to manufacture, completely avoids the problem of introducing foreign material into the oil pan, and can be checked whenever necessary merely by opening the hood. Within the scope of the present invention is the replacement of all the various dipsticks and other methods used to monitor fluid levels such as power steering fluid, brake fluid, battery electrolyte levels, windshield washer fluid, etc. and/or the use of an unified display for all the monitored reservoirs. Further, although the invention has been described with the display mounted under the hood, it would also be possible to mount the display in a variety of other locations such as on the dashboard or at any other convenient location.

It is to be understood that although the invention has been described with particular reference to specific embodiments thereof, the forms of the invention shown and described are to be taken as a non-limiting embodiment and various changes and modifications may be made to the invention without departing from its spirit and scope as defined by the Claims.

1. An optical sensor for detecting a level of a liquid in a reservoir, said optical sensor comprising:
a display;
a light pipe optically connected to said display and extending to a level of interest in said reservoir, where said light pipe is formed from a material having a refractive index higher than air's refractive index and less than or equal to said liquid's refractive index; and
a light optically connected to said light pipe.

2. The optical sensor of claim 1, where said light pipe is a plastic tube.

3. The optical sensor of claim 1, where said light pipe is an optical fiber.

4. The optical sensor of claim 1, where said light pipe is a glass rod.

5. The optical sensor of claim 1, where said light pipe is a plastic rod.

6. The optical sensor of claim 1, where said light is a light emitting diode.

7. An optical sensor for detecting a level of a liquid in a reservoir, said optical sensor comprising:
a display;
a plurality of light pipes optically connected to said display and each of said plurality extending to a different level of interest in said reservoir, where said light pipe is formed from a material having a refractive index higher than air's refractive index and less than or equal to said liquid's refractive index; and
a light optically connected to each of said plurality of light pipes.

8. The optical sensor of claim 7, where said plurality of light pipes are plastic tubes.

9. The optical sensor of claim 7, where said plurality of light pipes are optical fibers.

10. The optical sensor of claim 7, where said plurality of light pipes are glass rods.

11. The optical sensor of claim 7, where said plurality of light pipes are plastic rods.

12. The optical sensor of claim 7, where said light is a light emitting diode.

13. An optical sensor for detecting a level of a liquid in a reservoir, said optical sensor comprising:
a display;
a bundle of optical fibers optically connected to said display where each optical fiber in said bundle extends to a different level of interest in said reservoir, and each optical fiber is formed from a material having a refractive index higher than air's refractive index and less than or equal to said liquid's refractive index; and
a light optically connected to each optical fiber in said bundle.

14. The optical sensor of claim 13, where said light is a light emitting diode.
